(19) United States
(12) Patent Application Publication
(10) Pub. No.: US 2026/0241645 A1
(43) Pub. Date: Aug. 20, 2026

(54) PATH LAYING METHOD

(71) Applicant: Airbus Operations GmbH, HAMBURG (DE)

(72) Inventors: Jan BOYKSEN, HAMBURG (DE); Paul SAGER, HAMBURG (DE)

(21) Appl. No.: 19/541,858

(22) Filed: Feb. 17, 2026

(30) Foreign Application Priority Data
Feb. 19, 2025 (DE) 10 2025 000 620.9

(51) Int. Cl. B29C 70/38

(52) U.S. Cl. CPC B29C 70/382

(57) ABSTRACT

A path laying method for depositing endless fiber material on a surface of a component, wherein a laying path is divided into a plurality of path portions and each path portion is aligned on a surface portion over which the path portion extends, while complying with at least one technical condition. The technical condition may be a starting point, an end point, a constant fiber angle, a variable fiber angle, a material overlap, a spacing between draped fiber webs, or any combinations thereof.

### CROSS-REFERENCE TO RELATED APPLICATIONS

This application claims the benefit of German Patent Application No. 10 2025 000 620.9, filed on Feb. 19, 2025, the entire disclosure of which is incorporated herein by way of reference.

### FIELD OF THE INVENTION

The invention relates to a path laying method for depositing endless fiber material on a surface of a component.

### BACKGROUND OF THE INVENTION

Known methods for producing a fiber composite component are based on AFP technology and wrapping technology. While Automated Fiber Placement Technology (AFP) deposits an endless web of fiber material on a tool via a laying machine and presses it against the tool surface by a contact pressure roller, wrapping technology deposits or wraps the fiber material in webs about a mandrel. ADP technology is particularly suitable for the production of large-area components with a less complex surface. Wrapping technology is particularly suitable for the production of cylindrical hollow members such as pipes or tanks. The draping of fiber webs on complex surfaces, such as multi-curved components or components with variable cross sections, is problematic in both methods, because due to the complexity of the surface, a constant fiber angle cannot be maintained in the fully automated method, for example. Known measures for such components include manually cutting the fiber web and repositioning it in a changed position so that, for example, a constant fiber angle can be maintained.

An object of the invention is to provide a path laying method for depositing endless fiber material on a surface of a component, which in particular allows fully automated draping (draping without manual intervention) even on complex component surfaces.

### SUMMARY OF THE INVENTION

This object may be achieved with a path laying method having the features of one or more of the embodiments described herein.

A path laying method according to the invention for depositing endless fiber material on a surface of a component provides that a laying path is divided into a plurality of path portions. Each path portion is aligned on a surface portion over which the path portions extends, while complying with at least one predefined technical condition (technical parameter).

The invention is an incremental curvature-controlled path laying method that corrects the laying path or fiber path in such a way that a technical condition or technical parameter is complied with. For example, the method enables a constant fiber angle across the entire component. The path laying method can be applied to multi-curved surfaces of components, regardless of their size and shape.

The approach uses a logical method to check whether a subsequent surface of the component has been reached and on which surface it must continue the path generation in order to generate a continuous laying path. The surface of the component per se does not need to be discretized for this approach. It is not necessary to manually cut the fiber web and reattach it in order to comply with the technical condition.

In other words, a laying path which is previously divided into a plurality of path portions, each path portion being positioned on a surface portion in such a way that the at least one technical condition is complied with, is simulated.

Examples of technical conditions include a starting point of the fiber web, an end point of the fiber web, a constant fiber angle, a variable fiber angle, a material overlap and/or a spacing between draped fiber webs.

The path portions can have the identical length or a length adapted to a profile of the respective surface portion. For example, it is conceivable to iteratively adapt the length of the path portion until a curvature of the surface portion changes. This reduces the computing effort.

The incremental course of action can be achieved by aligning the path portions successively, starting at the end point of the respective directly preceding path portion. This ensures that the entire laying path has no jumps or offsets between the adjacent path portions.

Preferably, a direction vector of a subsequent path portion, which represents the length and the profile of the subsequent path portion without taking into account the contour of a surface portion over which the subsequent path portion is to extend, is applied at the end point of a path portion, and is projected on the surface portion. This ensures that the contour of the surface portion is accurately captured and thus also taken into account.

After each projection, it is checked whether the at least one technical condition is complied with. In the event of non-compliance, a correction procedure is started (taking into account tolerances) in which at least one correction factor is determined, by means of which the profile of the path portion over the surface portion is corrected in such a manner that the at least one technical condition is complied with.

In order to enable manual data entry and thus, for example, repositioning of the path, a partial parametrization of the component surface can be carried out, in the context of which guide points on which the laying path is aligned are defined on the surface. The path can then be displaced or repositioned by displacing the guide points.

In particular, it can be advantageous when the at least one technical condition is variable after generating one path portion and before generating a subsequent path portion. This can take place, for example, via an automatically generated query after depositing a path portion, which can then be manually responded to, either by maintaining or by locally adapting the at least one technical condition. This allows the component to be reinforced in local regions by changing the fiber profile, or to be modified in a different way.

Preferably, the path laying method is a wrapping method.

The wrapping technology in combination with the path decomposition according to the invention into a multiplicity of path portions enables the fully automated draping of fiber webs on components with a complex geometry. Examples of complex geometries are multi-curved surfaces.

These and other aspects and embodiments of the present invention, any of which may be combined in any manner with any other aspect, embodiment or configuration, will be appreciated by those of ordinary skill in the art based upon the following description of the drawings and detailed description.

### BRIEF DESCRIPTION OF THE DRAWINGS

Preferred exemplary embodiments of the invention will be explained in more detail hereunder by means of schematic illustrations. In the figures:

FIG. 1 shows a perspective top view of a component to be wrapped in an example, on which a conventional laying path and a laying path according to the invention are indicated;

FIG. 2a shows an illustration of a detail from FIG. 1, and

FIG. 2b shows an enlarged component portion for highlighting the path laying method according to the invention.

### DETAILED DESCRIPTION OF THE PREFERRED EMBODIMENTS

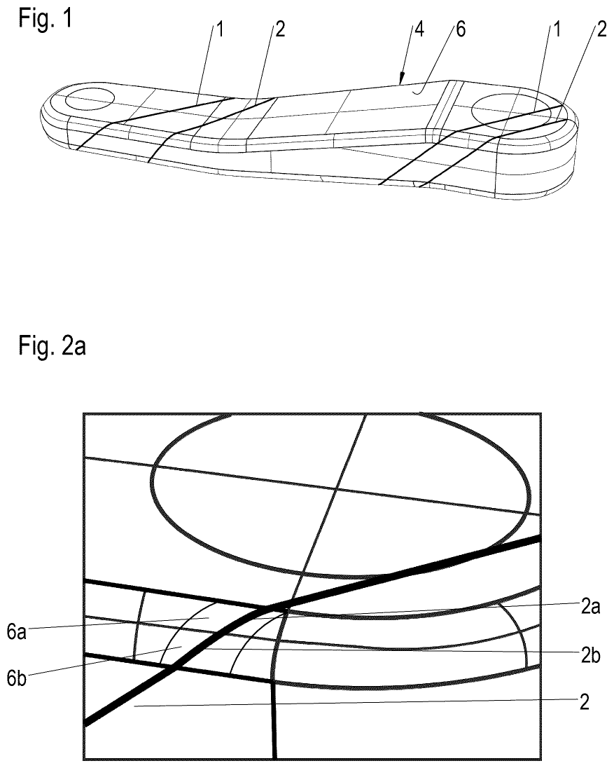

In FIG. 1, a comparison between two laying paths 1, 2 of fiber webs on an exemplary component 4 with a complex component surface 6 is visualized. The fiber web material to be deposited is identical in both cases. In each case, this is an endless material which is wrapped about the component, thus being deposited on the surface 6 of the latter. Examples include resin-preimpregnated fiber composite webs or dry fiber composite webs used in AFP technology methods. The difference between the laying paths is that, under the same technical parameters or conditions, the laying path 1 represents a conventional fiber web profile, and the laying path 2 shows a fiber web profile according to the path laying method according to the invention.

In the conventional path laying method, the technical parameters such as a starting point and an end point on the component surface 6 and a laying angle of, for example, 45°, are determined. A laying head of a laying machine then immediately starts at the starting point with the automatic depositing of the fiber web, while setting the fiber angle of 45°. Due to the complexity of the component surface 6, however, the fiber angle is not consistently maintained during wrapping, but the predetermined fiber angle changes automatically over time, with the consequence that the deposited fiber webs diverge or run so as to be unintentionally oblique relative to one another, resulting in gaps between them. The defined end point is not reached.

In the path laying method according to the invention, technical parameters or conditions such as a starting point and an end point on the component surface and a fiber angle of, for example, 45°, are likewise determined.

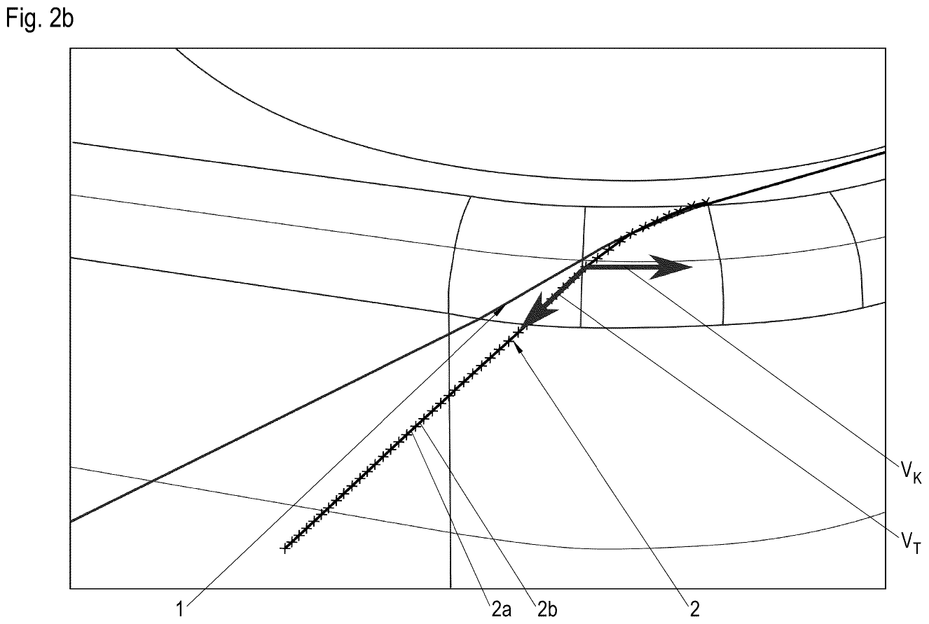

As highlighted in the detailed illustration in FIG. 2a, in the path laying method according to the invention, the laying path 2 is divided into a plurality of path portions 2a, 2b in the run-up to the actuation of the laying head of a laying machine, these path portions in combination then resulting in the laying path 2. The path portions 2a, 2b are each deposited on surface portions 6a, 6b, 6c of the component surface 6 in such a way that each of them enables compliance with all technical conditions, in particular compliance with the fiber angle of 45° over the entire wrapping process. After each defined path portion 2a, the positioning of the subsequent path portion 2b is determined, wherein the end point of the preceding path portion 2a is the starting point for the subsequent path portion 2b. After defining the last path portion, the profile of the laying path 2 is determined and the laying machine can begin depositing the fiber web. Due to the multiplicity of path portions 2a, 2b, the technical parameters are adhered to over the entire laying path 2, i.e., each fiber web is aligned at the specified fiber angle of 45°, so that the fiber webs run parallel to one another and the predefined end point is reached.

With reference to FIG. 2b, the path laying method according to the invention is explained by means of other laying paths 1, 2 on a component 4.

The solid line simulates a fiber web profile of a conventional laying path 1.

The transversely dashed line simulates a fiber web profile of a laying path 2 according to the path laying method according to the invention. It represents a correction of the conventional laying path 1 in such a manner that the technical conditions, such as constant fiber angle, are complied with. Two transverse lines each delimit a path portion 2a, 2b of the entire laying path 2. For this purpose, a direction vector Vᵣ and the length of a subsequent path portion 2b is placed in the end point of a preceding path portion 2a. The direction vector Vᵣ is then projected onto its associated surface portion 6b. It is subsequently determined whether the technical condition such as constant fiber angle is complied with. When a deviation is ascertained, it is investigated whether the deviation is within a defined tolerance range. If it is within the tolerance range, this path portion 2b is also defined and by way of its end point forms the starting point for a subsequent path portion 2c. If the deviation is outside the tolerance range, a correction procedure is performed in which at least one correction factor is established to determine the path portion 2b in conformity with the condition. A correction factor is, for example, a correction vector Vₖ, which causes the direction vector Vᵣ to be displaced laterally. As soon as the overall path is determined based on the technical parameters and the component surface 6, the laying data is transferred to a laying machine. The latter then begins with the fully automated depositing of the fiber webs, in compliance with the technical conditions, over the entire wrapping process or draping process.

For example, in order to change local fiber angles, which means a conscious change of the predefined fiber angle, a user can, for example in response to an automated query, perform a manual entry before the path laying method determines a subsequent path portion 2b.

The path laying method according to the invention is in two parts. In a first step, an optimal laying path 2 is determined by decomposition into a plurality of path portions 2a, 2b. A manual intervention in the path profile can take place when, for example, a technical parameter for a local surface portion 6a, 6b of component 4 is to be changed. When the entire laying path 2 is determined, the laying path 2 is transferred in a second step to a laying machine which then carries out, or can carry out, the depositing of the fiber webs on a component surface 6 according to the predetermined laying path 2 fully automatically. A laying head of the laying machine travels over the component 4 according to the laying path 2, whereby the fiber web is deposited on the component surface 6 according to the laying path 2. Manual interventions during the depositing of the fiber webs are not necessary, as the laying path 2 has been defined in advance in compliance with technical parameters.

By introducing basic laminate information (technical conditions) with respect to the starting point of the draping and the local fiber angle targets, a continuous laying path 2 is generated on a referenced component surface 6, wherein the laying path 2 can be manipulated in different ways. Examples include predefined defined guide points on component surface 6, which the fiber web must travel over, or manual inputs before a subsequent path portion 2b is generated. The path laying method according to the invention for producing endless fiber paths uses a logical method to check whether the next surface portion 6b of the component 4 has been reached and on which subsequent surface area 6b it must continue with the fiber web generation in order to generate a continuous fiber web. For the fiber web generation, a discretization approach is used to generate small path portions 2a, 2b with a specific direction vector Vᵣ (fiber orientation) on the surface portion 6a, 6b, to read a surface normal vector and to project the path portions 2a, 2b on the respective surface portion 6a, 6b relative to the surface normal of the respective path portion 2 a, 2 b. The component surface 6 per se is not discretized in the path laying method according to the invention. The path laying method then generates at the end point (end node) of the previously projected path portion 2a a line with the new local direction vector Vᵣ that is present at the end node. This line is projected relative to the new local surface normal at the end node. These method steps are now repeated until an end criterion is met.

The invention relates to a path laying method for depositing endless fiber material on a surface of a component, wherein a laying path is divided into a plurality of path portions and each path portion is aligned on a surface portion over which the path portion extends, while complying with at least one technical condition.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 Conventional laying path
2 Laying path according to the invention
2a, 2b Path portion
4 Component
6 Component surface/surface
6a, 6b Surface portion
Vᵣ Direction vector
Vₖ Correction vector

Claimed is:

1. A path laying method for depositing endless fiber material on a surface of a component, the path laying method comprising:
dividing a laying path is divided into a plurality of path portions and each path portion of the plurality of path portions aligned on a surface portion over which the path portion extends, while complying with at least one predefined technical condition.

2. The path laying method according to claim 1, wherein the at least one technical condition is selected from a group consisting of: a starting point; an end point; a constant fiber angle; a variable fiber angle; a material overlap, a spacing between draped fiber webs, and combinations thereof.

3. The path laying method according to claim 1, wherein the plurality of path portions have an identical length or a length adapted to a profile of the respective surface portion.

4. The path laying method according to claim 1, further comprising:
aligning the plurality of path portions successively, starting at an end point of a respective directly preceding path portion from the plurality of path portions.

5. The path laying method according to claim 4, wherein a direction vector of a subsequent path portion from the plurality of path portions, which represents a length and a profile of the subsequent path portion without taking into account a contour of a surface portion over which the subsequent path portion is to extend, is applied at an end point of a path portion from the plurality of path portions and is then projected onto the surface portion.

6. The path laying method according to claim 5, wherein, in a case of non-compliance with the at least one technical condition after the direction vector is projected, the method further comprising:
determining at least one correction factor by which the profile of the subsequent path portion over the surface portion is corrected so that the at least one technical condition is complied with.

7. The path laying method according to claim 1, further comprising:
defining guide points on which the laying path is aligned on the component surface.

8. The path laying method according to claim 1, wherein the at least one technical condition is variable after generating one path portion from the plurality of path portions and before generating a subsequent path portion from the plurality of path portions.

9. The path laying method according to claim 1, wherein the fiber material is wrapped about the component.
